(19) United States
(12) Patent Application Publication
(10) Pub. No.: US 2019/0161025 A1
(43) Pub. Date: May 30, 2019

(54) Hood Ornament Cover

(71) Applicant: Thomas W. Dunn, Saltillo, MS (US)

(72) Inventor: Thomas W. Dunn, Saltillo, MS (US)

(21) Appl. No.: 15/823,537

(22) Filed: Nov. 27, 2017

(51) Int. Cl. B60R 13/00

(52) U.S. Cl. CPC B60R 13/005

(57) ABSTRACT

A hood ornament cover to protect a hood ornament of a vehicle such as an automobile, truck, motorcycle, semi-truck, or boat, from weather and debris that would otherwise impact the hood ornament and thus cause damage the hood ornament.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC

Not Applicable

### DESCRIPTION

### Field of the Invention

This disclosure relates to a hood ornament cover in the shape of a hood ornament to protect the hood ornament from weather and debris that otherwise causes damage, pitting, or abrasions to the hood ornament during the normal operation of the vehicle.

### Background of the Invention

Hood ornaments are status symbols of vehicles. However, over time, with regular use of the vehicle, the hood ornament of a vehicle can become damaged, pitted, or abraded as a result of weather and debris that impacts the hood ornament. At present, an alternative method of protecting a hood ornament has not been revealed.

### SUMMARY OF THE INVENTION

The present disclosure reveals a hood ornament cover in the shape of a hood ornament of a vehicle to protect a hood ornament from weather and debris that would otherwise damage the hood ornament. The hood ornament cover comprises a plurality of pieces of material assembled together by stitching, an adhesive, or heat fusion. The hood ornament cover further comprises an opening that allows the hood ornament to be inserted into the hood ornament cover and a closure that allows the hood ornament cover to be secured to the hood ornament of the vehicle. The closure of the hood ornament cover may be comprised of Velcro, straps, zippers, or laces

### BRIEF DESCRIPTION OF THE SEVERAL VIEWS OF THE DRAWING

FIG. 1 is an image of a hood ornament cover on the hood of a vehicle;

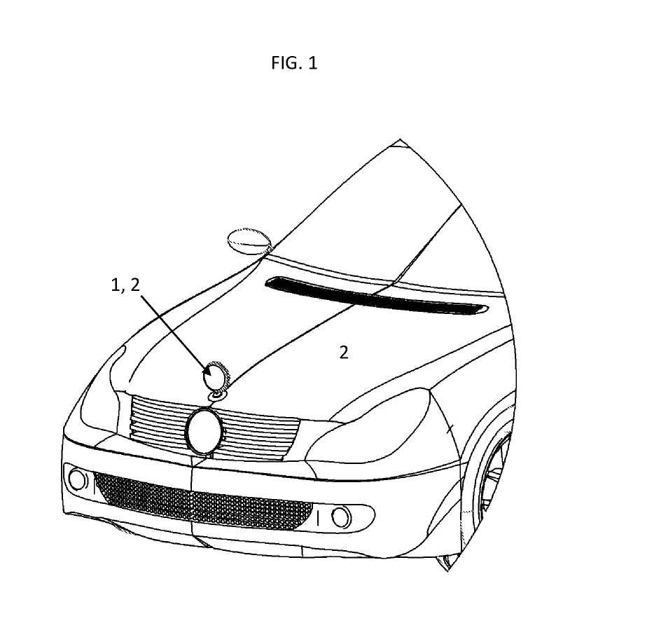

FIG. 2 is a view of a hood ornament cover assembled with the use of stitching;

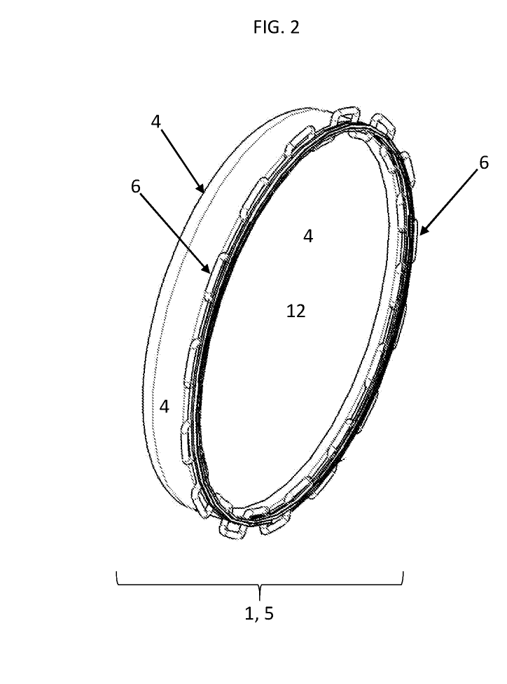

FIG. 3 is a view of a hood ornament cover assembled with the use of adhesive;

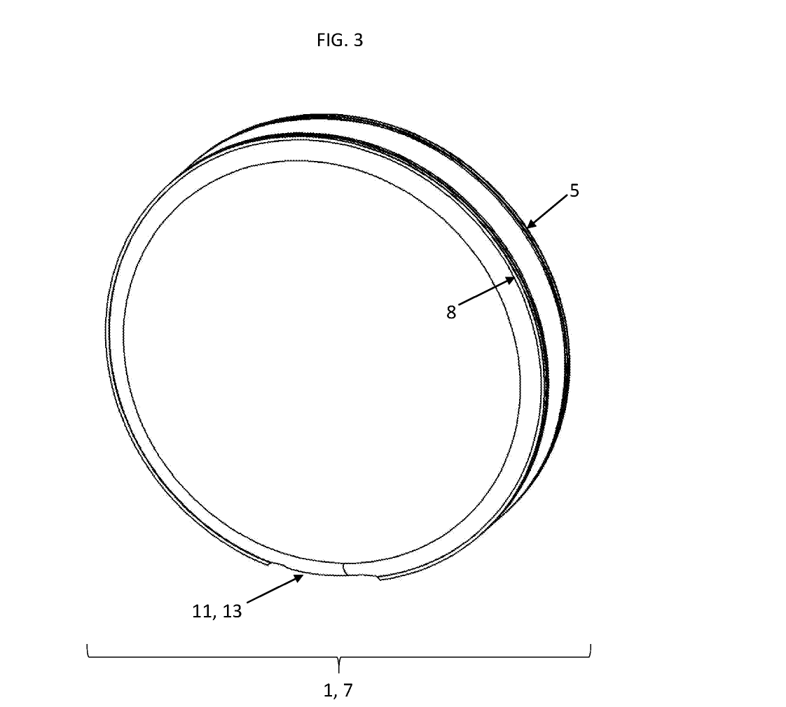

FIG. 4 is a view of a hood ornament cover assembled with the use of heat fusion;

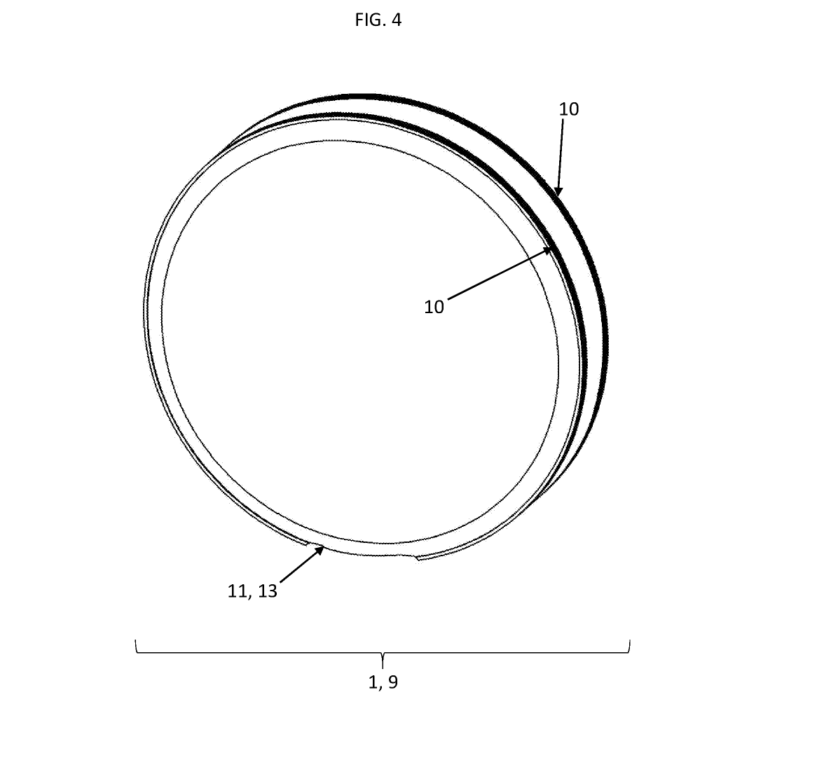

FIG. 5 is a view of a hood ornament cover assembled as an extrusion of rubber or plastic;

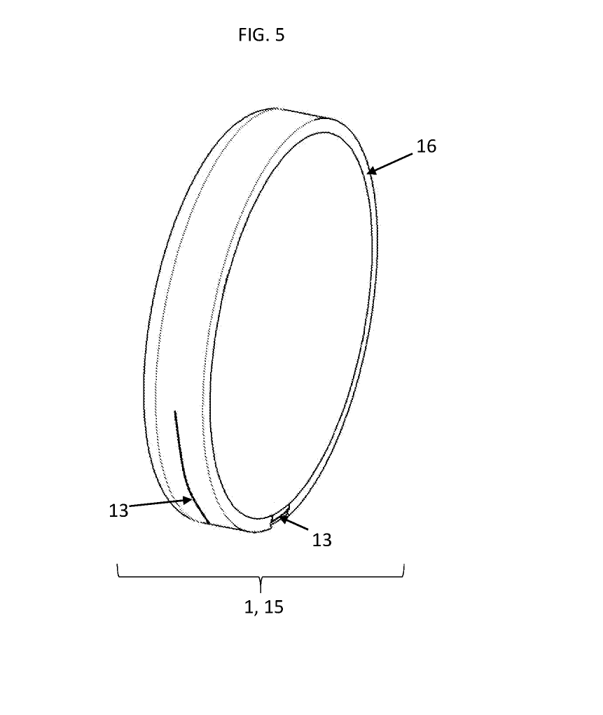

FIG. 6 is a view of a hood ornament cover opening wherein the opening can be closed with the use of Velcro;

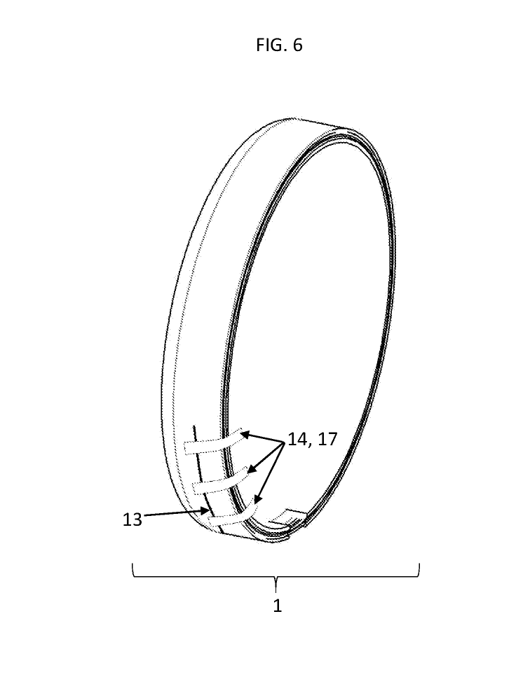

FIG. 7 is a view of a hood ornament cover opening wherein the opening can be closed with the use of straps;

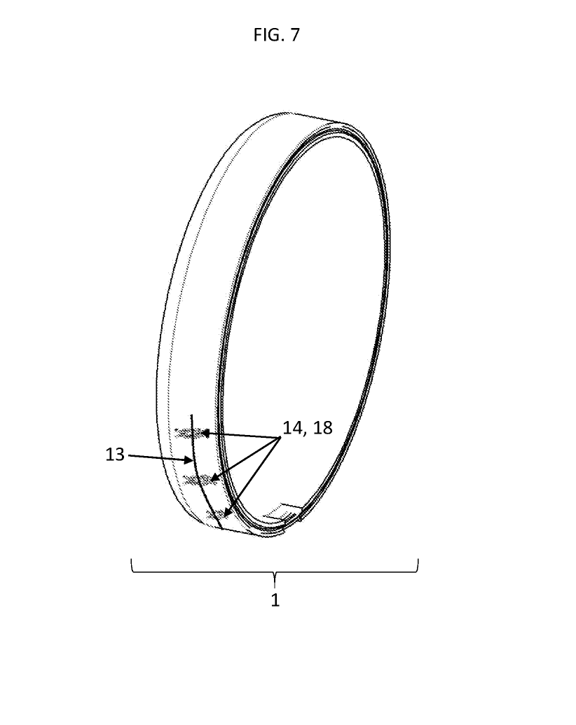

FIG. 8 is a view of a hood ornament cover opening wherein the opening can be closed with the use of zippers; and

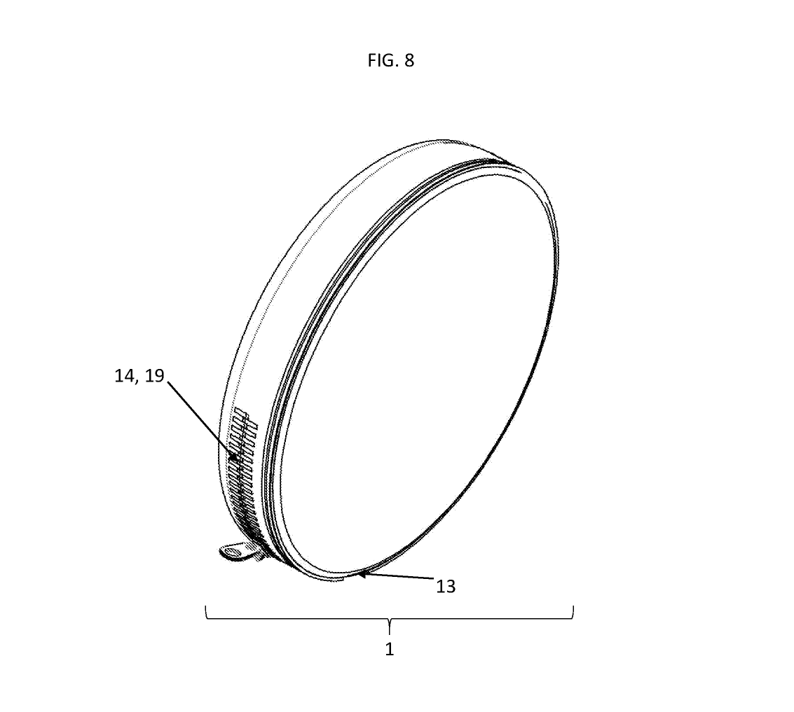

FIG. 9 is a view of a hood ornament cover opening wherein the opening can be closed with the use of laces.

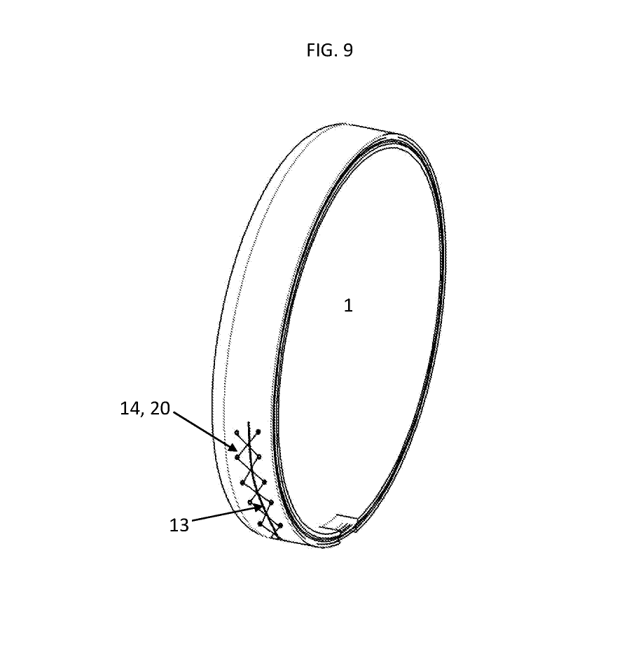

### DETAILED DESCRIPTION OF THE INVENTION

The present disclosure reveals a hood ornament cover 1 to protect a hood ornament 2 of a vehicle 3 from weather and debris that may otherwise damage the hood ornament 2, types of vehicles 3 including but not limited to cars, motor cycles, boats, trucks, or semi-trailers, said hood ornament cover 1 comprising a plurality of pieces of material 4 assembled together in the in the shape of the hood ornament 2. Wherein said plurality of pieces of material 4 are resistant to the weather and abrasive material that otherwise impacts the hood ornament 2. The plurality of pieces of material 4 being selected from at least one of leather, canvas, vinyl, plastic, or rubber. Wherein there are four embodiments of the assembly of the hood ornament cover 1, with the first embodiment 5 being stitching 6, the second embodiment 7 being the use of an adhesive 8, the third embodiment 9 being the use of heat fusion 10, and the fourth embodiment 15 being from an extrusion 16 of the shape from plastic or rubber. In the event the hood ornament cover 1 is assembled with stitching 6 said stitching 6 is made of thread, wherein the thread is made of at least one material including but not limited to cotton polyester, silk, rayon, metallic. In the event heat fusion 10 is used to assemble the hood ornament cover 1, the plurality of pieces of material 4 are heated to such an extent that they bond with each other.

When the hood ornament cover 1 is assembled the hood ornament cover 1 further comprises an inside 11, an outside 12, and an opening 13. The opening 13 allows the hood ornament 2 to be inserted into the inside 11 of the hood ornament cover 1. The hood ornament cover 1 further comprises a closure 14 around the opening 13 to allow the hood ornament cover 1 to be secured to the hood ornament 2, and wherein said closure 14 is comprised of at least one of Velcro 17, straps 18, zippers 19, or laces 20.

What is claimed:

1. A hood ornament cover to protect a hood ornament of a vehicle from weather and debris that may otherwise damage the hood ornament, types of vehicles including but not limited to cars, motor cycles, boats, trucks, or semi-trailers, said hood ornament cover comprising:
a plurality of pieces of material assembled together in the in the shape of the hood ornament;
wherein said plurality of pieces of material are resistant to the weather and abrasive material that otherwise impacts the hood ornament;
said plurality of pieces of material being selected from at least one of leather, canvas, vinyl, plastic, or rubber;
wherein the hood ornament cover is assembled together with the use of stitching;
wherein, when the hood ornament cover is assembled there is an inside, an outside, and an opening;
wherein the opening allows the hood ornament to be inserted into the inside of the hood ornament cover;
wherein said hood ornament cover further comprising a closure around the opening.

2. The hood ornament cover of claim 1 wherein the hood ornament cover also with the use of an adhesive.

3. The hood ornament cover of claim 2 wherein the hood ornament cover also with the use of heat fusion.

4. The hood ornament cover of claim 1 wherein the hood ornament cover also with the use of heat fusion.

5. A hood ornament cover to protect a hood ornament of a vehicle from weather and debris that may otherwise damage the hood ornament, types of vehicles including but not limited to cars, motor cycles, boats, trucks, or semi-trailers, said hood ornament cover comprising:
a plurality of pieces of material assembled together in the in the shape of the hood ornament;
wherein said plurality of pieces of material are resistant to the weather and abrasive material that otherwise impacts the hood ornament;
said plurality of pieces of material being selected from at least one of leather, canvas, vinyl, plastic, or rubber;
wherein the hood ornament cover is assembled with the use of an adhesive;
wherein, when the hood ornament cover is assembled there is an inside, an outside, and an opening;
wherein the opening allows the hood ornament to be inserted into the inside of the hood ornament cover;
wherein said hood ornament cover further comprising a closure around the opening.

6. The hood ornament cover of claim 1 wherein the hood ornament cover also with the use of stitching.

7. The hood ornament cover of claim 2 wherein the hood ornament cover also with the use of heat fusion.

8. The hood ornament cover of claim 1 wherein the hood ornament cover also with the use of heat fusion.

9. A hood ornament cover to protect a hood ornament of a vehicle from weather and debris that may otherwise damage the hood ornament, types of vehicles including but not limited to cars, motor cycles, boats, trucks, or semi-trailers, said hood ornament cover comprising:
a plurality of pieces of material assembled together in the in the shape of the hood ornament;
wherein said plurality of pieces of material are resistant to the weather and abrasive material that otherwise impacts the hood ornament;
said plurality of pieces of material being selected from at least one of leather, canvas, vinyl, plastic, or rubber;
wherein the hood ornament cover is assembled with the use of heat fusion;
wherein, when the hood ornament cover is assembled there is an inside, an outside, and an opening;
wherein the opening allows the hood ornament to be inserted into the inside of the hood ornament cover; and
wherein said hood ornament cover further comprising a closure around the opening.

10. The hood ornament cover of claim 9 wherein the hood ornament cover also with the use of stitching.

11. The hood ornament cover of claim 10 wherein the hood ornament cover also with the use of an adhesive.

12. The hood ornament cover of claim 9 wherein the hood ornament cover also with the use of an adhesive.

13. A hood ornament cover to protect a hood ornament of a vehicle from weather and debris that may otherwise damage the hood ornament, types of vehicles including but not limited to cars, motor cycles, boats, trucks, or semi-trailers, said hood ornament cover comprising:
a plurality of pieces of material assembled together in the in the shape of the hood ornament;
wherein said plurality of pieces of material are resistant to the weather and abrasive material that otherwise impacts the hood ornament;
said plurality of pieces of material being selected from at least one of molded plastic or molded rubber that are extruded in the shape of the hood ornament;
wherein, when the hood ornament cover is assembled there is an inside, an outside, and an opening;
wherein the opening allows the hood ornament to be inserted into the inside of the hood ornament cover;
wherein said hood ornament cover further comprising a closure around the opening.

14. The hood ornament cover of claim 13 wherein the hood ornament cover is assembled together with the use of stitching.

15. The hood ornament cover of claim 14 wherein the hood ornament cover is assembled together with the use of an adhesive.

16. The hood ornament cover of claim 15 wherein the hood ornament cover is also assembled together with the use of heat fusion.

17. The hood ornament cover of claim 13 wherein the hood ornament cover is also assembled together with the use of an adhesive.

18. The hood ornament cover of claim 17 wherein the hood ornament cover is also assembled together with the use of heat fusion.

19. The hood ornament cover of claim 13 wherein the hood ornament cover is also assembled together with the use of heat fusion.
